(19) United States
(12) Patent Application Publication
(10) Pub. No.: US 2002/0197517 A1
(43) Pub. Date: Dec. 26, 2002

(54) Fuel cell enhancement process

(76) Inventor: Winston MacKelvie, Knowlton (CA)

Correspondence Address: Winston MacKelvie, Box 1156, Knowlton, QC, J0E 1V0, CA

(21) Appl. No.: 10/177,207

(22) Filed: Jun. 21, 2002

Related U.S. Application Data
(60) Provisional application No. 60/300,358, filed on Jun. 22, 2001.

(51) Int. Cl. H01M 8/02

(52) U.S. Cl. 429/13; 429/38

(57) ABSTRACT

The present invention discloses a process to add a thin, active coating to all of the passageways, ports, and flow field channels of an assembled fuel cell or fuel cell stack. The coating substance may include, alone or in combination, ionomers (such as Nafion®), wicking fibers, catalyst, sealants, and water absorbents. The coating provides, alone or in combination, water management, electrochemistry enhancements, porosity control, and leak-seal functions. The invention is carried out in five steps. In the first step a coating fluid is prepared containing the desired substance(s) and a diluting carrier fluid such as alcohol. In the second step, the coating fluid is pumped or vacuum drawn into the cell/stack via an existing external connections (inlet/outlet ports). In the third step, the surplus coating fluid is removed by purging and/or vacuuming, leaving only a thin, coating or deposit behind. In the fourth step vacuuming and/or heating and/or spinning of the cell/stack is used to evaporate the carrier fluid. In the fifth step the stack is heated to a temperature that sets, inverts micelle structures, or otherwise makes the coating permanent. The process may be repeated to thicken the deposited layer or to add substances successively.

The present application is a continuation-in-part of provisional application number 60/300,358 filed Jun. 22, 2001 Confirmation Number 6722. The present invention is in the field of fuel cells and other such electrochemical devices including electrolyzers. It addresses water management, catalyst dispersion, sealing, porosity control, and extending of the active area of the proton exchange membrane (PEM).

### FIELD OF THE INVENTION

### BACKGROUND OF THE INVENTION

A fuel cell stack has several external connections (hose/pipe/tube fittings) for supplying gaseous reactants (air/oxygen and hydrogen) and for exhausting waste products (water, surplus reactants). These external connections communicate with internal manifold passages that extend through and to each cell of the fuel cell stack. Communicating with the manifolds are the flow field channels in the individual planar flow field plates of each cell. These channels are often in a serpentine ‘maze’ across the faces of the flow field plates and are designed to deliver and distribute reactant evenly across the face of an adjacent planar porous electrode. The electrode has its opposite face laden with catalyst particles and pressed against a planar ionomer membrane. The desired electrochemical reaction takes place at those catalyst sites where reactant, electrode, and membrane all adjoin or contact one another.

Thus the external connections communicate directly with all of the internal passageways of a fuel cell/stack right up to and including the membrane.

The nature, design, and arrangement of these fuel cell components create problems that limit fuel cell performance (performance, by which is meant: power output, size, weight, reliability, cost, and economy of operation).

One problem is water management. It is imperative that the entire membrane be maintained in a fully hydrated state across its entire surface so that it may remain both an insulator to electron flow and an efficient conductor of protons. However, inherent with protonic conduction, is that, as each (hydrogen) proton moves through the membrane it also takes a number of water molecules from the membrane which dehydrates the membrane. This water must constantly be replaced to keep the membrane fully hydrated. Another water management problem, is, that, because water is the byproduct of fuel cell operation and because all or parts of a fuel cell operates below the boiling point of water, liquid water may form droplets in the small flow channels blocking gas (air/oxygen) flow which greatly reduces cell performance. A further problem in the water management field is the need to supply water across the entire membrane quickly in response to increased power demand (more proton flow). There exists a need for improved fuel cell water management on both sides of the membrane.

Yet another problem is leakage. All the planar fuel cell components (which may number in the hundreds) each have numerous openings, channels, vias, ports and the like for reactant and exhaust flows, tie rods, and coolant. Each and every one of these openings through each cell component must be made gas-tight to their respective fluids. Once the sandwich of planar cell components are all heavily clamped together between thick, metallic end plates to produce a finished fuel cell stack, any gas leaks from the many hundreds of potential leak sites, have to be ‘lived with’. There is no corrective measures that can be taken. Leaks can produce unwanted heat, raise the danger of explosion, and add to operational costs. In other words, gas leaks inevitably lead to poor cell performance. Too much leakage leads to rejection and the cell stack will have to be dismantled which is both expensive and damaging to the delicate components. Further the exact location of the leakage cannot be easily determined or corrected. There is need for a post-assembly method of sealing leaks.

Another problem is the porosity of the materials, in particular, the graphite materials used in the flow field plates. These plates have flow channels on the opposite faces, one face spreading hydrogen, the other air/oxygen. No cross flow of reactants through these plates should occur. However, graphite, by its nature, is porous to a greater or lesser extent, lesser porosity adding cost. Graphite plates are therefore impregnated with sealants to minimize gas flow through the plates' thickness. For performance (to maximize power-to-weight/cost/size) the thinnest possible plates are best Thus the porosity problem is exasperated as performance gains are sought. Furthermore, impregnating components before assembly can reduce electrical conductivity due to residual sealant adding to contact resistance on the component faces. There is need for a solution to the porosity problem.

Yet another problem relates to catalysts in a fuel cell. The catalyst particles occupy a substantially flat plane adjacent the planar membrane where the catalyst, membrane (solid electrolyte), and electrode adjoin. This limited planar area limits the number of catalyst sites that are available to the reactants. Further, the need to maximize catalyst sites make the problem of catalyst agglomeration, caused by polarity attraction between particles, results in reduced performance. There is need for improved catalyst distribution.

Thus the sealing of the components; the delivery of hydration water; the removal of process water; the prevention of water droplet blockage of the channels; the distribution of the catalyst; and increased electrochemical activity, reducing porosity, and sealing leaks, are all existing problems whose solution is the objective of the present invention.

### SUMMARY OF THE INVENTION

The objectives of the present invention are achieved by the process of using one or more of the external reactant connections or ports (the external ‘plumbing’) to fill the assembled and compressed cell/stack with a coating fluid comprising a carrier fluid to which is added a desired coating substance(s). After filling, the excess coating fluid is removed and the carrier fluid evaporated so as to leave behind the coating substance as a thin coating on the walls of the passageways of each and every cell in a fuel cell stack.

The excess coating fluid is removed by purging the cell/stack, while the remaining carrier fluid is removed by heating and/or vacuum and /or spinning the cell/stack. The cell/stack may then be further heated to a predetermined temperature to change or invert the deposited coating into a permanent, insoluble form.

By adding the substance after the fuel cell stack is fully assembled, all the established electrical contacts between conductive components throughout the stack remain unaffected.

By this present process, sealants, wick fibers, water absorbents, catalysts, and/or an ionomer, alone or in any combination, may be evenly dispersed throughout the myriad internal vias, passageways, ports and manifolds of an assembled cell or cell stack to improve fuel cell performance.

### BRIEF DESCRIPTION OF THE DRAWINGS

FIG. 1 shows a representation of a typical assembled fuel cell stack made of numerous individual cells clamped between end plates and external inlet and outlet connected to reservoirs of coating fluids;

FIG. 2 shows an enlarged cross section of a portion of FIG. 1 showing the individual cell components and further showing a comparison between bare and coated flow field channels;

FIG. 3 shows one representative bi-polar flow field plate in perspective with coated manifold ports and flow field channels.

### DETAILED DESCRIPTION OF THE INVENTION

The present process invention is preferably employed after individual cells B are assembled and fully clamped together between end plates C, C′ with tie rod J (one shown through stack center) into a fuel cell stack A. At this final stage of assembly, high pressure contact has been fully established between all conductive components (electron and proton) including the flow field plates M, anode electrodes F, cathode electrodes H, membranes G, and end plates C, C′. In FIG. 2 the effect is shown where the membrane electrode assembly is shorthened at K to show the coating 10 not coating the flow field plate in areas between channels 10 where such contact has been made.

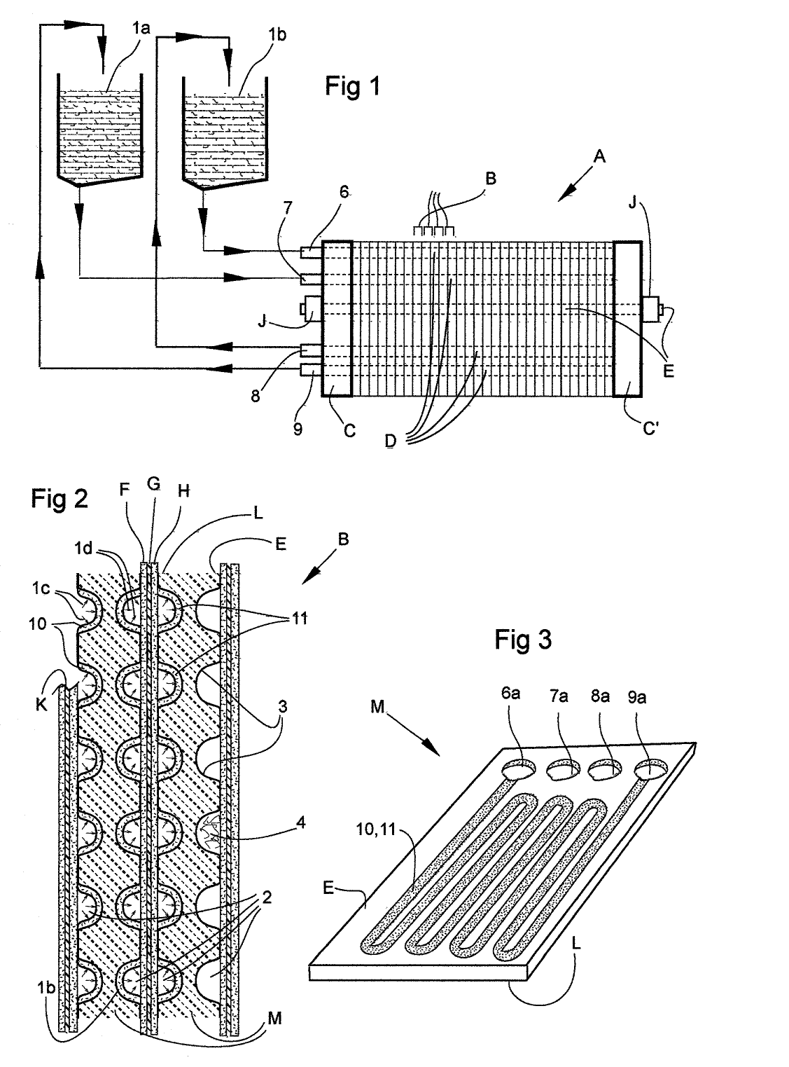

To distribute the reactants to each cell from a single external connection, ports or openings are made through each component of each cell such as anode ports 6a, 9a and cathode ports 7a, 8a. In bipolar flow field plate M (FIG. 3) the ports are aligned during assembly whereupon they form internal manifolds D (FIG. 1). These openings also extend through both electrodes F, G and membrane G. All must be gas tight. Coolant passages (not shown) may also add to the openings through each cell. All openings as well as the cell's perimeter must be gas tight for high performance. One object of the invention is to form-in-place a continuous coating 1 on all openings and passageways to assist in making a gas tight stack.

By the present invention, the preferred substance(s) 1a, 1b is/are made to coat 10, 11 all the normally bare walls of the serpentine flow field channels 4, internal manifolds D, the interior of connections 6, 7, 8, 9, ports/manifolds 6a, 7a, 8a, 9a (FIG. 3), (all hereafter referred to as internal conduits) of each and every cell B of assembled stack A. Stated otherwise, the object of the present invention is to coat, case, line, cast, deposit, or otherwise disperse a substance(s) on the internal conduits of an assembled fuel cell stack.

The invention is carried out as follows:

1. prepare at least one coating fluid 1a, 1b comprising the substance(s) and a carrier fluid;

2. flow the coating fluid 1a, 1b through the assembled stack A using one or more external connections 6, 7 ,8 9. The stack may first be evacuated. The stack may also be continually rotated.

3. withdraw surplus coating fluid 1a, 1b from an external connection 6, 7, 8, 9 thereby leaving behind a coating 10, 11 on the internal conduits of the cell(s), including flow field channels 2.

4. evaporate the carrier fluid so as to leave coating 1 on internal conduits.

4. treat stack A to make coating 1 insoluble.

The substance(s) chosen may be different for the anode E and cathode L sides of the bipolar flow field plate M. That is, different ionomers, different catalysts and different fibers types may be selected for coating 11 in the air/oxygen environment than those used in coating 10 in the hydrogen environment. The filling of cell/stack A may be accomplished by pumping the coating fluid 1a, 1b into the cell. A preferred method of filling the cell is to apply a vacuum at one or more of the external connections 6, 7, 8. 9, to thereby draw the fluid 1a. 1b in from another one or more of the external connections 6, 7, 8, 9. This vacuum method minimizes air pockets and minimizes coating the electrodes should this be desired. If the stack is spinning while being filled, the electrodes may be further protected from impregnation if desired.

The coating fluid 1a, 1b is preferably a carrier fluid such as water or alcohol, mixed with, alone or in combination: wicking fibers; water absorbents; catalyst particles; sealants; catalysts; ionomers.

A preferred coating fluid la would be an alcohol carrier fluid mixed with an ionomer solution (such as 5% Nafion® solution made by duPont Inc.) along with fibers and catalyst particles. By varying the volume of alcohol the viscosity of the coating fluid 1a, 1b can be adjusted as required. Using these preferred substances, the following benefits are realized:

1. the fibers provide water management from their inherent wicking action by automatically and continually moving water from wetter to drier areas immediately that any drying begins. This ensures a more even supply of humidification water to all parts of the membrane. This is one objective of the present invention. Further, wicking fibers cause excess water to ‘flow out’ or wet the interior conduits walls rather than forming physical droplets that lead to gas flow blockage. This is another objective of the present invention.

2. the fibers also provide a mechanical reinforcement to the deposited coating 10, 11 to ensure it maintains it's form and attachment to the internal conduit walls. The fiber reinforcement also enables the coating to resist vibration, temperature changes, gas flow, and the like.

3. the ionomer coating provides protonic and water conduction paths to (or from) the membrane G. It also provides leak sealing, porosity sealing, membranous encasement of electrical conduction sites, and provides adhesion of coating 10, 11 to the interior counduit walls. These are all objectives of the present invention.

4. the catalyst adds electrochemical reaction sites along the coating 10, 11 adding enormously to the potential reaction sites, another objective of the present invention.

Thus by this simple, low cost process, very many unexpected performance benefits can be realized. Essentially no redesign of the fuel cell is required to make use of the present invention.

The coating fluid 1a, 1b may be made into a solution, a suspension, a foam, a colloidal suspension, a dispersion, a solid-liquid mixture, a gaseous mixture, or any other suitable vehicle to carry the desired substance into the internal conduits.

After wetting or filling the cell/stack, the coating fluid 1a, 1b is removed by suction, purging, flushing, blowing, vacuum, and/or drying/spin-drying, to thereby leave at least some of the substance behind as a formed-in-place coating 10, 11 on the internal conduits of stack A.

After removal of the excess carrier fluid, the entire cell stack A may be heated to a temperature or otherwise acted/reacted on to convert the coating 10, 11 into an insoluble form. For example, when commercially available Nafion® ionomer solution dries on a surface, it forms a membrane or film. However, it is known that this ‘cast-from-solution’ membrane or film is resoluble in water (Analytical Chemistry, 1996, pg. 3793-3796). However, if the dried film is heated to a specific temperature, the molecular micelle structure of the ionomer is inverted and the ionomer film is made insoluble. This molecular restructuring occurs at 284° F. (140° C.) according to Zook and Leddy (ibid) or at 176° F. (80° C.) according to Moore and Martin (Analytical Chemistry 1986, 5M, pg. 2569-70). Because this is not a drying operation, the heating of the cell/stack to these temperatures can be done in a full humid atmosphere.

In summary, by using the present invention, a substance may be formed-in-place on the walls of the internal conduits of an assembled cell B or stack A forming a thin, permanent coating 10, 11. The coating fluid 1a, 1b preferably contains fibers, catalyst particles, and an ionomer solution, and is diluted with alcohol to provide the coating thickness required and for fast, complete drying. The more dilution, the thinner the resultant coating.

In more detail. A coating 10, 11 bearing wicking fibers will provide more even hydration of the membrane on the hydrogen side by distributing available water more evenly across the flow field plates M and thus across the membrane G. Wick fibers will also allow continuous water evaporation 1d from the entire wetted wall into the passing hydrogen stream assuring more even membrane hydration even downstream from the hydrogen inlet. On the oxygen side the wick will assist water removal 1c from the electrode, spreading the water throughout the flow field channel 2, leaving the center free of water droplets for unimpeded gas flow. On both sides of the membrane, the wick-bearing coating 10, 11 will prevent unwanted water droplet formation, drawing the droplets by capillary action into a wall-bound water film. Some of the main manifolds D may have a water mist injected to keep the coating 11 wet ensuring maximum water transportation to membrane.

To absorb any sudden increase in water use/production due to a sudden increase power production from stack A, a water-absorbing substance may also be added to coating fluid 1a, 1b such as those used by EPE Industrial Filters Inc., USA (1-847-381-0860). In this way water may be temporarily stored throughout the cell in coating 10, 11.

A coating 10, 11 of ionomer has numerous benefits to the performance of stack A, some are mechanical and others electrochemical. Mechanically, when the ionomer coating dries, a film is left coating the internal conduits. This film or membrane has binding properties to ensure that it and the fibers remain in place. The dry film also has hydrophillic properties which acts to assist the fibers in the spread and distribution of water. The ionomer will also creep into tiny voids and, when dry, will act as a sealant against gas leakage. The ionomer film will also encase and thereby seal against porosity of the flow field plate E. The extended membrane will also provide more conduction paths for protons. Further, the ionomer may be allowed to penetrate the electrode F, H and reach the membrane G of the cell, thus providing a continuous path from manifold(s) D to membrane G for maximum water management and electrochemical activity. The electrodes F, H may be made from a material having a larger than normal void structure to accommodate the partial narrowing of such voids by the coating 10, 11 deposited on the web defining the voids. The ionomer solution may also be further diluted so as to thin the deposit and reduce its effect on the porous electrode. Further, it may be preferred to use a different ionomer on each side of the membrane, with each ionomer being selected for the type of ion conduction required at that location.

Adding a catalyst to coating 10, 11 will distribute catalyst throughout the cell creating many more three-phase contact sites where conductor, catalyst, and membrane are adjoined (in mutual contact) thereby speeding ionization of the reactants.

It is feasible to use the present invention to add the entire catalyst loading after stack A assembly using an ionomer in alcohol to carry it throughout the cell. The stack A may them be heated to fully evaporate the alcohol and convert the cast membrane coating 1 to an insoluble state (whereby the molecular micelle structure is inverted).

For wick material, cellulose, propylene, graphite, or even curled wool may be used. Excess coating fluid 1a, 1b may by withdrawn through a temporary filter (not shown) at the appropriate connection 6, 7, 8, 9 so as to leave larger fibers 4 behind throughout the interior counduits of the stack A (in FIG. 2, only one flow field channel shown filled with fibers). In this way, a wick of fibrous material may be formed in place filling the interior conduits with loosely packed fiber. The process may be repeated to make a thicker/denser wick. Wick materials may be separately acted on by successive fluids to accomplish such things as unwinding pre-curled fiber. For example, compressed and dried wool fiber mixed with an ionomer and alcohol may be flowed through a cell from an inlet connection with a filter on the outlet connection. This will allow the liquid to escape but trap the fiber in the stack's possageways, After drying, the remaining wool fiber may be acted on by water to cause the wool fiber to uncurl or unwind. Other substances may benefit from a second cell filling with another substance where the two substances react to create a third substance with the necessary properties. For example, filling a cell with a liquid to provide a first coating may be followed by a second filling with a reactive gas to convert the first coating to an insoluble solid.

Another method of casting a wick structure in place would be to use a foamed coating fluid 1a, 1b whereupon it's bubbles would bust in the interior conduits creating a splatter of web-like wicking structures in the internal conduits.

Further, by using a mix of an ionomer plus catalyst for coating fluid 1a, 1b, the planar membrane G gets protonically connected to the anode F and to the anodic flow field channels 10. Because the ionomer coating 10, 11 is hydrophilic, and proton conductive, the active surface area of the membrane is extended. Another objective of the present invention.

If a catalyst such as platinum is added to the ionomer, all the electrodes and channel wall surface area become capable of catalyzing reactions increasing stack performance. A catalyst may be chosen for the coating fluid 1a, 1b to act to purify the hydrogen gas (i.e., of carbon monoxide) before it reaches the primary membrane.

A carrier gas may also be used to carry a particulate. A filter at the outlet end allows the gas to escape and the particulate to build up in the passages. The gas may also carry a substance in vapor form which condenses on cooler interior surfaces of the cell.

The present process may be repeated to thicken the cast web in the cell/stack and/or to add additional layers of other substance(s) therein.

Other variations of post-processing of cells may be utilized without detracting from the essence of the present invention.

I claim

1. A method of improving the operating characteristics of an assembled fuel cell having internal passage means and external connection means in fluid communication with said internal passage means, the method comprising the steps of providing a carrier fluid containing a coating material, passing said fluid through said external connection means to said internal passage means such that said fluid will flow through said internal passage means, and removing surplus fluid from said external connection means while at least a portion of said coating material is left to coat surfaces within said internal passage means.

2. The method of claim 1 wherein the step of providing said fluid comprises the step of providing a fluid additionally containing a catalyst.

3. The method of claim 1 wherein the step of providing said fluid comprises the step of providing a fluid additionally containing a plurality of fibers.

4. The method of claim 1 wherein said coating material is an inomer.

5. In a fuel cell having at least one internal passage for transport of reactants, the improvement wherein said internal passage is covered with a coating material, said coating material having been introduced into said fuel cell after assembly thereof such that said coating material will coat substantially all exposed surfaces of said internal passages.

6. The improvement of claim 5 wherein said coating material includes a plurality of fibers therein.

7. The improvement of claim 5 wherein said coating material is an ionic material.

8. The improvement of claim 5 wherein said coating material has sealing properties.

9. The improvement of claim 5 wherein said coating material additionally contains a catalyst for use in said fuel cell.
